(19) United States
(12) Patent Application Publication
(10) Pub. No.: US 2026/0175243 A1
(43) Pub. Date: Jun. 25, 2026

(54) Pressure washer and method for operating a pressure washer

(71) Applicant: Andreas Stihl AG & Co. KG, Waiblingen (DE)

(72) Inventors: Simon Nadler, Stuttgart (DE); Rainer Grohmann, Ludwigsburg (DE); Stefan Baßmann, Backnang (DE)

(73) Assignee: Andreas Stihl AG & Co. KG, Waiblingen (DE)

(21) Appl. No.: 19/425,207

(22) Filed: Dec. 18, 2025

(30) Foreign Application Priority Data
Dec. 20, 2024 (DE) 102024139282.7

(51) Int. Cl. B05B 7/32; B05B 9/00; B05B 9/01

(52) U.S. Cl. CPC B05B 7/32; B05B 9/007; B05B 9/01

(57) ABSTRACT

A pressure washer (1) includes a main line (5) through which liquid can be delivered by a high-pressure pump (3), a control element (42) with which the size of a liquid volume flow of the liquid in the main line (5) can be influenced on the basis of a control signal generated by the control element (42), and a mixing device (80) with which the liquid can be fed an additive (81) with an additive volume flow. The mixing device (80) sets the size of the additive volume flow on the basis of the control signal.

### CROSS-REFERENCE TO RELATED APPLICATION

This application claims the benefit of German Patent Application DE 102024139282.7, filed on Dec. 20, 2024, the content of which is incorporated by reference in its entirety.

### BACKGROUND

EP 4 389 296 A1 discloses a pressure washer in which the pressure in the main line can be predetermined by actuating a control element. An auxiliary pump is provided in order to mix an additive with the liquid delivered in the main line. The pump output is regulated depending on the pressure in the main line. For this purpose, the pressure in the main line is determined by means of a pressure gauge. Using a pressure gauge is structurally complex and expensive.

### SUMMARY

The present disclosure is based on the object of refining a generic pressure washer in such a way that the additive volume flow can easily be adapted to the liquid volume flow. This object is achieved by a pressure washer as disclosed and claimed.

A further object of the disclosure is to refine a generic method for operating a pressure washer in such a way that the size of the additional volume flow can easily be adapted to the size of the liquid volume flow. This object is achieved by a method as disclosed and claimed.

The pressure washer comprises a main line through which liquid can be delivered by means of a high-pressure pump. In particular, the pressure washer, especially the main line, comprises a dispensing nozzle. In particular, the pressure washer, especially the main line, comprises a connection for a liquid source. In particular, liquid can be delivered from the connection to the dispensing nozzle through the main line by means of the high-pressure pump.

In the pressure washer, the size of the liquid volume flow of the liquid in the main line can be influenced on the basis of the control signal generated by the control element. The liquid, particularly the main line, can be fed additives by means of a mixing device, especially in a branch line. The additive is the liquid with an additive volume flow. The mixing device sets the size of the additive volume flow on the basis of the control signal. The pressure in the main line therefore does not need to be measured. There is no need to use a pressure gauge. This simplifies the design of the pressure washer and saves costs. Because both the liquid volume flow and the additive volume flow can be influenced, and in particular changed or in particular set, on the basis of the control signal, it is easily ensured that the size of the additive volume flow also increases with a larger liquid volume flow. This allows the concentration of the additive in the liquid to be kept almost or completely constant even with a larger liquid volume flow in the main line. There is no need for complex regulation of the pump output of the mixing device.

In particular, the control signal is generated by an operator by actuating the control element.

In particular, the liquid volume flow can be influenced, and in particular changed, by means of the control element so that the size of the liquid volume flow can assume at least three different values. Therefore, the liquid volume flow can not only be changed between zero and a maximum value, but can also assume at least one value between zero and a maximum value. In particular, the liquid volume flow can be influenced, and in particular changed, in particular set, by means of the control element so that it can assume several different values between zero and a maximum value. In particular, the liquid volume flow can be influenced, and in particular changed, in particular set, by means of the control element so that the size of the liquid volume flow can be adjusted quasi-continuously, and in particular continuously.

In particular, the size of the liquid volume flow can be influenced depending on a degree of actuation of the control element. In particular, the control element can be continuously adjusted between an initial position, in particular a rest position, and an end position, in particular an end position. In particular, the intensity of the control signal increases with increasing distance of the control element away from the rest position towards the end position, and in particular with increasing degree of actuation. In particular, the liquid volume flow increases the further the control element is moved from the rest position towards the end position. This allows the size of the liquid volume flow to be influenced, in particular predefined, and in particular set, within a defined range of values by means of the control element. This enables convenient and simple adjustment of the liquid volume flow to the respective operating conditions.

In particular, the size of the additive volume flow depends on the degree of actuation of the control element. Because both the size of the liquid volume flow and the size of the additive volume flow depend on the degree of actuation of the control element, it is ensured that the size of the liquid volume flow and the size of the additive volume flow are interdependent. The larger the liquid volume flow, the larger also the additive volume flow. This easily ensures that the concentration of the additive in the liquid remains approximately or exactly constant, even when the size of the liquid volume flow changes.

In particular, the control signal, in particular the intensity of the control signal, depends on the degree of actuation of the control element. The greater the degree of actuation of the control element, the greater in particular the intensity of the control signal. In particular, the intensity of the control signal increases with increasing distance of the control element away from the rest position towards the end position.

In a particular refinement, the pressure washer comprises a volume flow setting device. The volume flow setting device is used to set the liquid volume flow, in particular the size of the liquid volume flow in the main line. In particular, both the volume flow setting device sets the liquid volume flow in the main line and the mixing device sets the size of the additive volume flow on the basis of the control signal, in particular on the basis of the intensity of the control signal. Provision may be made for the control signal to be received directly as an input signal by both the volume flow setting device and the mixing device. In particular, the pressure washer comprises a control unit. In particular, a liquid volume flow signal and an additive volume flow signal are generated in the control unit on the basis of the control signal. In particular, the liquid volume flow signal is sent by the control unit to the volume flow setting device and used there directly to set the size of the liquid volume flow. In particular, the additive volume flow signal is sent by the control unit to the mixing device and used there directly to set the size of the additive volume flow.

In particular, the mixing device receives the additive volume flow signal in order to set the size of the additive volume flow. In particular, the additive volume flow signal is ascertained, in particular determined, exclusively on the basis of the control signal. In particular, there is no need to measure the pressure or the liquid volume flow in the main line in order to determine the additive volume flow signal. The additive volume flow signal, in particular the intensity of the additive volume flow signal, is ascertained, in particular determined, independently of the actual liquid volume flow present in the main line, in particular independently of the size of the liquid volume flow actually present in the main line. This allows the additive volume flow signal, and in particular the intensity of the additive volume flow signal, to be easily ascertained, in particular determined. In particular, the additive volume flow signal can also be the control signal itself. In this case, the interposition of a control unit is not required.

In particular, the pressure washer is configured so that the size of the additive volume flow is proportionally dependent on the size of the liquid volume flow in the main line. This allows a constant concentration of the additive in the liquid to be achieved even if the size of the liquid volume flow changes.

In particular, the mixing device is an auxiliary pump. In particular, the additive is fed into the liquid in the main line by means of the auxiliary pump. In particular, the additive volume flow is present in a feed line to the main line. In particular, the mixing device, in particular the auxiliary pump, delivers the additive independently of the high-pressure pump. In particular, the mixing device is not a hydraulic actuator. In particular, the mixing device, in particular the auxiliary pump, is the primary energy source for the liquid movement of the additive. In particular, the additive is liquid. In particular, the mixing device, in particular the auxiliary pump, generates energy in the form of pressure or flow.

In particular, the size of the additive volume flow can be set by clocking an electrical power, in particular an electrical energy, with which the mixing device, in particular the auxiliary pump, is operated. In particular, the clocking of the electrical power, in particular the electrical energy, can be set by means of the control signal generated by the control element. The clocking of the electrical power, in particular the electrical energy, can be achieved, in particular, by means of pulse width modulation of the electrical power, in particular energy, fed to the mixing device, in particular the auxiliary pump. The pulse width can then be set depending on the degree of actuation of the control element, in particular depending on the control signal, and in particular depending on the intensity of the control signal. For example, the pulse width can be chosen to be smaller the further the control element is moved away from the rest position towards the end position. In particular, the pulse width can be chosen to be smaller the larger the control signal, in particular the intensity of the control signal. The size of the additive volume flow can also be adjusted by setting an operating frequency of the mixing device, in particular the auxiliary pump. The size of the additive volume flow can also be set via phase-angle control if the mixing device, in particular the auxiliary pump, is operated with AC voltage.

Provision may also be made for the mixing device to be an adjustable valve. In particular, the mixing device is a Venturi nozzle with an adjustable flow cross section, in particular with an adjustable minimum flow cross section.

In particular, the volume flow setting device comprises a bypass line. The main line has a suction chamber and a pressure chamber. The high-pressure pump is arranged between the suction chamber and the pressure chamber. In particular, the pressure chamber is fluidically connected to the suction chamber via a bypass line. In particular, a bypass valve is arranged in the bypass line. The bypass valve serves to regulate the liquid volume flow in the pressure chamber of the main line. A free cross-sectional area of the bypass line can be set by means of the bypass valve. In particular, the bypass valve can be actuated, at least indirectly, by means of the control element. In particular, the bypass valve can be actuated depending on the control signal generated by the control element, in particular depending on the intensity of the control signal. In particular, the volume flow setting device comprises, besides the bypass line, the bypass valve and an actuator with which the bypass valve can be adjusted so that the free cross-sectional area of the bypass line can be set. In particular, the free cross-sectional area can be set depending on the control signal, in particular the intensity of the control signal. Because the regulation of the liquid volume flow, in particular the size of the liquid volume flow, is achieved by means of a bypass valve, the pressure washer can be manufactured cost-effectively. The regulation of the liquid volume flow, in particular the size of the liquid volume flow, is achieved completely independently of the type of motor used to drive the high-pressure pump. Accordingly, a cost-effective motor can be used, and at the same time, the liquid volume flow, in particular the size of the liquid volume flow, can be regulated. This eliminates the need for a costly speed control for a motor. Expensive measures such as the integration of a frequency converter or the implementation of phase-angle control are not required. In particular, the use of a directly driven asynchronous motor with corresponding speed control can be dispensed with.

In an alternative configuration, the liquid volume flow in the pressure chamber can be regulated depending on the speed of the motor driving the high-pressure pump. In this case, no bypass line is provided. The size of the liquid volume flow then depends on the speed of the motor. In particular, the speed of the motor can be influenced, in particular predetermined, in particular set, by means of the control element, in particular depending on the control signal generated by the control element, in particular depending on the intensity of the control signal, in particular depending on the degree of actuation of the control element. This configuration saves installation space. No extra bypass line needs to be provided.

In particular, an inlet of the mixing device, in particular the auxiliary pump, is fluidically connected to a container for the additive. This allows the additive to be easily fed to the mixing device. The container is in particular designed to be replaceable within the pressure washer. This allows the additive container to be easily replaced when the additive is used up. Provision may also be made for the container to be refillable.

Advantageously, the mixing device, in particular the auxiliary pump, is an oscillating armature pump. This allows the auxiliary pump to be designed to be particularly compact. This results in the auxiliary pump requiring only little installation space. This enables a compact design for the pressure washer overall. This results in low energy consumption for delivering the additive. In particular, the oscillating armature pump is a vibration pump. However, provision may also be made for the auxiliary pump to be an oscillating armature diaphragm pump.

The additive is, in particular, a cleaning agent solution. This enables effective cleaning of the objects hit by the liquid jet by means of the liquid sprayed from the dispensing nozzle.

In the method for operating a pressure washer, provision is made for the pressure washer to comprise a main line through which liquid can be delivered with a liquid volume flow by means of a high-pressure pump, for the pressure washer to be configured so that the size of the liquid volume flow can be changed, in particular predetermined, in particular set, and for the liquid to be able to be fed an additive with an additive volume flow, and for the same control signal to be used both in order to set the size of the liquid volume flow and in order to set the size of the additive volume flow.

This is connected with the advantages described above for the pressure washer according to the disclosure.

In particular, the control signal is generated by a control element of the pressure washer being actuated, in particular by an operator.

In particular, the control signal depends on a degree of actuation of the control element. This is connected with the advantages described above in connection with the pressure washer.

In particular, both the size of the liquid volume flow and the size of the additive volume flow are set on the basis of the control signal. This eliminates the need to measure the size of the liquid volume flow. This also eliminates the need to regulate the additive volume flow.

The method for operating a pressure washer can be refined analogously to the refinements of the pressure washer described above. This is connected with the advantages described in this context.

Exemplary embodiments of the invention are explained below with reference to the drawing.

### BRIEF DESCRIPTION OF THE DRAWINGS

FIG. 1 shows a perspective view of a pump unit of a pressure washer,

FIGS. 2 and 3 show perspective views of a hand-held spray unit of the pressure washer,

FIG. 4 shows a side view of the hand-held spray unit according to FIGS. 2 and 3,

FIG. 5 shows a schematic view of a pressure washer with a volume flow setting device in the form of a bypass line with a bypass valve and actuator for the bypass valve, and with a mixing device for delivering additives into the liquid,

FIG. 6 shows a schematic view of a pressure washer with a volume flow setting device in the form of a high-pressure pump and a motor to drive it, and with a mixing device for delivering additives into the liquid,

FIG. 7 shows a schematic view of the pressure washer from FIG. 5 with maximum liquid volume flow in the main line and maximum additive volume flow,

FIG. 8 shows a view analogous to FIG. 7, but with half the liquid volume flow in the main line and half the additive volume flow,

FIG. 9 shows a schematic view of the pressure washer from FIG. 6 with maximum liquid volume flow in the main line and maximum additive volume flow,

FIG. 10 shows a view analogous to FIG. 9, but with half the liquid volume flow in the main line and half the additive volume flow,

FIG. 11 shows a sectional view through the hand-held spray unit from FIGS. 2 to 4 with the control element and valve control element unactuated,

FIG. 12 shows a sectional view analogous to FIG. 11 with the valve control element actuated and the control element unactuated,

FIG. 13 shows a sectional view analogous to the sectional view from FIG. 11 with the valve control element actuated and the control element actuated,

FIG. 14 shows a detail from FIG. 11 and

FIG. 15 shows a detail from FIG. 13.

### DETAILED DESCRIPTION

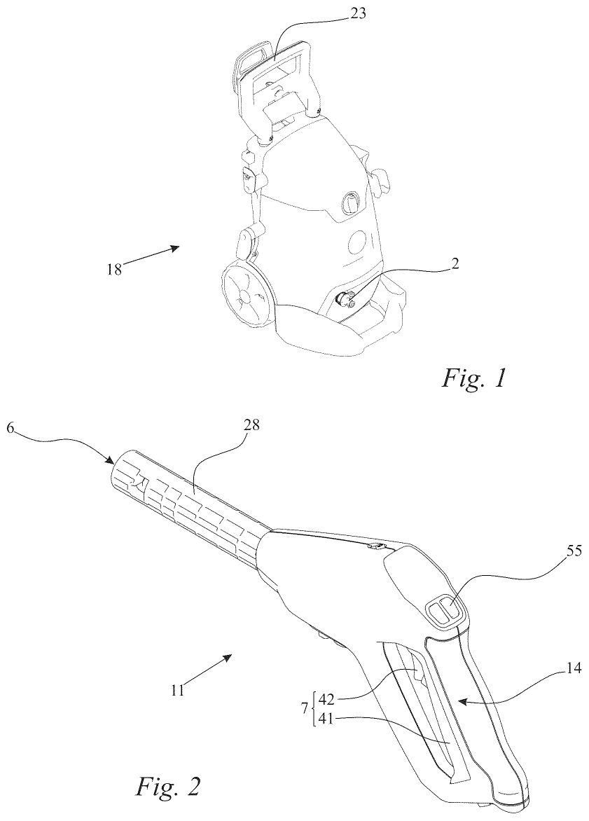

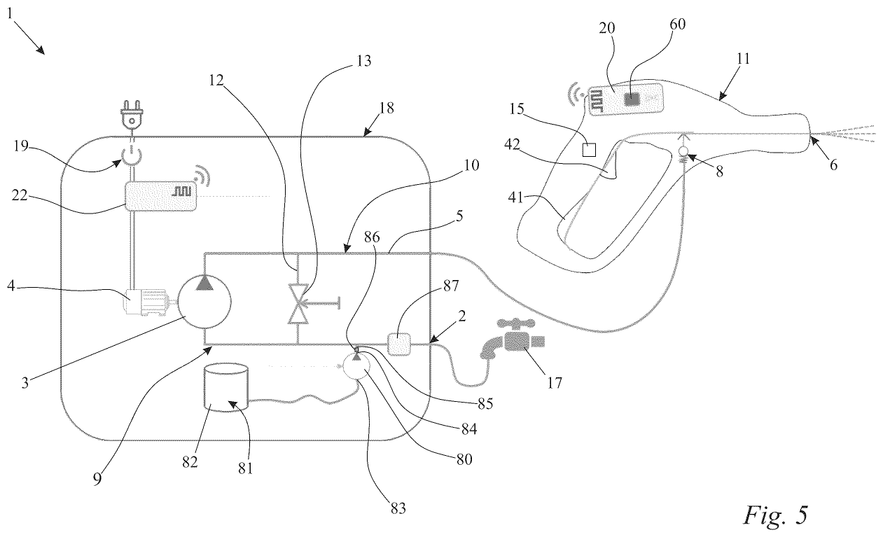

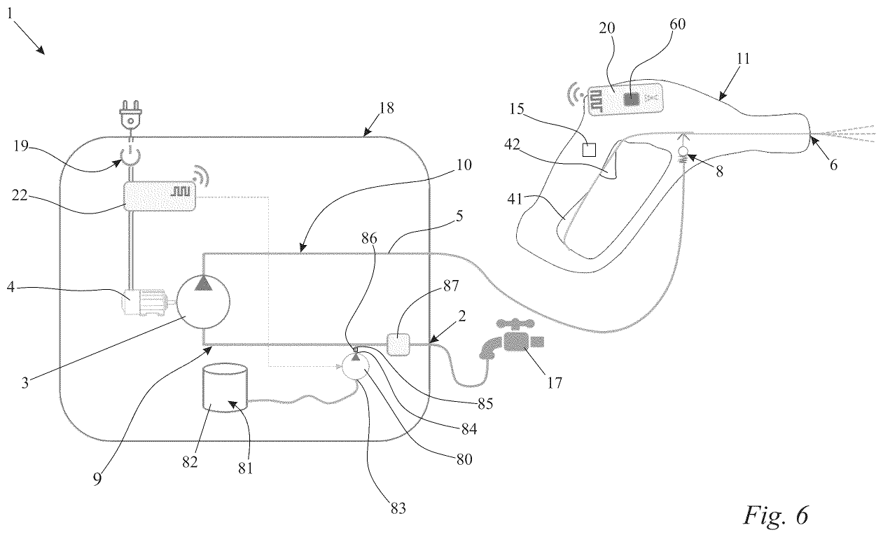

FIG. 1 shows a pump unit 18 of a pressure washer 1 schematically depicted in FIG. 5. The pump unit 18 can also be designed according to the alternative exemplary embodiment shown in FIG. 6.

In both embodiments of the pressure washer 1, the pressure washer 1 comprises a dispensing unit 11. The dispensing unit 11 can be designed as a pistol, as schematically depicted in FIG. 5 or FIG. 6. A dispensing nozzle 6 is arranged on the pistol. Alternatively, the dispensing unit 11 can be designed as a pistol with a lance 28, as shown in FIGS. 2 to 4. In this case, the dispensing nozzle 6 is arranged on the lance 28.

In all embodiments, the volume flow of liquid in a main line 5 can be influenced, in particular changed, and in particular set, by means of a volume flow setting device 25. The embodiments shown in FIGS. 5 and 6 differ in the configuration of the volume flow setting device 25.

A total of four different embodiments are therefore shown in the drawing. The following description applies to all exemplary embodiments unless explicitly stated otherwise—even if the corresponding features are only described in connection with one of the figures.

The pressure washer 1, in particular the spray unit 11, is configured for cleaning objects with pressurized cleaning liquid. In the exemplary embodiments, the pressure washer 1 is portable. The pressure washer 1 has a handle 23 as shown in FIG. 1. The pressure washer 1, in particular the pump unit 18 of the pressure washer 1, can be carried by the handle 23. In normal operation, provision is made for the pressure washer 1, in particular the pump unit 18, to be put down.

As shown in FIG. 5 or 6, the pressure washer 1 has a high-pressure pump 3. The high-pressure pump 3 is part of the pump unit 18. Liquid in the pressure washer 1, in particular in the pump unit 18, can be pressurized by means of the high-pressure pump 3. In particular, the liquid is water, in particular a mixture of water and an additive. The additive is in particular a cleaning agent solution, in particular a soap solution. In particular, the cleaning agent is liquid. By means of the high-pressure pump 3, the liquid can be pressurized to a pressure of at least 10 bar, in particular at least 15 bar, in particular at least 30 bar, in particular at least 100 bar. In particular, the high-pressure pump 3 can pressurize the liquid to a maximum pressure of 600 bar, in particular a maximum pressure of 500 bar. The high-pressure pump 3 comprises at least one piston (not shown). The at least one piston can be moved back and forth to generate pressure on the liquid. The high-pressure pump 3 typically comprises three pistons.

As shown in FIGS. 1 and 5 or 6, the pressure washer 1, in particular the pump unit 18, comprises a connection 2 for a liquid source 17. In the exemplary embodiments, the liquid source 17 is an external liquid source. In the exemplary embodiments, the external liquid source is the tap of a domestic water supply. It is also possible for the liquid source to be an integral part of the pressure washer 1. The pressure washer 1, in particular the handheld dispensing unit 11, comprises a dispensing nozzle 6.

As shown in FIG. 5 or 6, the pump unit 18 and the dispensing unit 11 are fluidically connected to one other via a main line 5 in all embodiments. The pressure washer 1 comprises the main line 5. The main line 5 fluidically connects the connection 2 to the dispensing nozzle 6. The connection 2 is arranged on the pump unit 18. The dispensing nozzle 6 is arranged on the dispensing unit 11. In the exemplary embodiment according to FIGS. 2 to 4, the dispensing nozzle 6 is arranged on a lance 28 of the dispensing unit 11. In the exemplary embodiment according to FIG. 5 or FIG. 6, the dispensing nozzle 6 is arranged on the dispensing unit 11, which is designed as a pistol.

By means of the high-pressure pump 3, liquid can be delivered from the connection 2 to the dispensing nozzle 6 via the main line 5. The liquid source 17 supplies liquid to the main line 5. The high-pressure pump 3 is arranged in the main line 5. The high-pressure pump 3 pressurizes the liquid. High-pressure pump 3 is arranged between a suction chamber 9 and a pressure chamber 10 of the main line 5. This is shown in FIG. 5 or FIG. 6. The main line 5 has the suction chamber 9 between the connection 2 and the high-pressure pump 3. The main line 5 has the pressure chamber 10 between the high-pressure pump 3 and the dispensing nozzle 6. In the exemplary embodiments, the suction chamber 9 is formed by a section of main line 5 between the connection 2 and the high-pressure pump 3. In the exemplary embodiments, the pressure chamber 10 is formed by a section of the main line 5 between the high-pressure pump 3 and the dispensing nozzle 6. This section of the main line 5 extends in particular exactly from the high-pressure pump 3 exactly to the dispensing nozzle 6. The high-pressure pump 3 delivers liquid from the suction chamber 9 to the pressure chamber 10. The pressure in the pressure chamber 10 is higher than in suction chamber 9. The suction chamber 9 and the pressure chamber 10 are components of the main line 5. Downstream of the high-pressure pump 3, the pressure in the main line 5 is higher than upstream of the high-pressure pump 3.

The high-pressure pump 3 is arranged in the pump unit 18. The high-pressure pump 3 is designed to be separate from the spray unit 11. Different spray units 11 can be connected to the high-pressure pump 3. The pressure washer 1 has a motor 4 to drive the high-pressure pump 3. The motor 4 is arranged in the pump unit 18. The motor 4 can be a brushless DC motor. A brushless DC motor is also called an EC motor. The motor can also be a universal motor. In the exemplary embodiments, the motor 4 is an induction motor. In an induction motor, a rotating magnetic field of the stator sets the rotor in motion. The induction motor in the exemplary embodiments is operated with alternating current. The voltage source can be, for example, the mains voltage. If battery or rechargeable battery operation is planned, the motor can also be a brushless DC motor. Provision may then be made for the rechargeable battery to be a component of the pressure washer 1. In particular, provision may then be made for the pump unit 18 to be a component of the hand-held spray unit 11. In this case, the entire pressure washer 1 is portable and hand-held during operation. In particular, the pump unit and the spray unit are then integrally designed. In particular, the pump unit and the spray unit are then arranged in a common housing. In particular, the pump unit and the spray unit are rigidly connected to one other, in particular not via a flexible hose. In particular, the main line 5 is then arranged in a single housing.

As shown in FIG. 5 or 6, the pressure washer 1 comprises a main switch 19. The main switch 19 serves to interrupt the power supply to the entire pressure washer 1. The main switch 19 is arranged on the pump unit 18.

The pressure washer 1 comprises a main line valve 8. The main line valve 8 is arranged in the main line 5. In the exemplary embodiments, the main line valve 8 is arranged in the injection unit 11. The main line valve 8 has a closed state and a fully open state. In the fully open state, the main line valve 8 allows liquid to flow through the main line 5. In the fully open state, the flow cross-section of the main line 5 is at its maximum at the position of the main line valve 8. Further opening of the main line valve 8 does not result in a larger flow cross-section for the liquid in the main line 5 at the position of the main line valve 8 when the valve is fully open. When closed, the main line valve 8 completely prevents any flow of liquid through the main line 5. When the main line valve 8 is fully open, liquid is sprayed out of the dispensing nozzle 6 during operation of the pressure washer 1. When the main line valve 8 is closed, no liquid is sprayed out of the dispensing nozzle 6. In the exemplary embodiments, the main line valve 8 is arranged between the high-pressure pump 3 and the dispensing nozzle 6. However, it is also possible for the main line valve 8 to be arranged within the pump unit 18. Provision may also be made for the main line valve 8 to be arranged between the connection 17 and the high-pressure pump 3.

The pressure washer 1 comprises the volume flow setting device 25 shown in FIG. 5 or, in an alternative embodiment, in FIG. 6. The pressure in the main line 5, in particular in the pressure chamber 10, can be influenced, in particular changed, and in particular set, by means of the volume flow setting device 25.

The pressure washer 1, in particular the spray unit 11, has an operating device 7. The operating device 7 is designed to be separate from the main switch 19. The volume flow setting device 25 can be operated by means of the operating device 7.

In particular, the main line valve 8 can be switched between the fully open state and the closed state by means of the operating device 7. In the exemplary embodiments, the operating device 7 is arranged on the injection unit 11.

The operating device 7 generates a control signal which depends on an actuation, in particular on a degree of actuation of the operating device 7. On the basis of the control signal, the volume flow setting device 25 sets the liquid volume flow of the liquid in the main line 5, in particular in the pressure chamber 10.

In the exemplary embodiments, the operating device 7 includes a valve control element 41 and a control element 42. The valve control element 41 is used to actuate the main line valve 8, in particular to switch between the closed state and the fully open state. The control element 42 is used to actuate the volume flow setting device 25. Alternatively to the exemplary embodiments, provision may also be made for the operating device 7 to be able to consist of a single control element which serves to actuate both the main line valve 8 and the volume flow setting device 25. For example, provision may also be made for the single control element to be able to be adjustable along an adjustment path. Upon initial actuation of the single control element, first of all the main line valve 8 is opened and, after traversing part of the adjustment path, the volume flow setting device 25 is then actuated and the liquid volume flow in the main line 5, in particular in the pressure chamber 10, is changed, in particular set. Depending on the degree of actuation, and also depending on the length of the traversed part of the adjustment path, the volume flow setting device 25 then sets the liquid volume flow, in particular the pressure, in the main line 5, in particular in the pressure chamber 10. In particular, the single control element generates a control signal which depends on the degree of actuation of the control element, based on which signal the volume flow setting device 25 sets the liquid volume flow, in particular the pressure, in the main line 5, in particular in the pressure chamber 10.

In the exemplary embodiments, the operating device 7 comprises the control element 42 and the valve control element 41. The control element 42 can be operated independently of the valve control element 41. The pressure washer 1, in particular the spray unit 11, is configured so that the valve control element 41 can be actuated without actuating the control element 42. Provision may be made for the pressure washer 1, in particular the spray unit 11, to be configured so that the control element 42 can be actuated without simultaneously actuating the valve control element 41. However, such a coupling can also be provided. In particular, provision may be made for the control element 42 to be able to be mechanically depressed without the valve control element 41 being simultaneously depressed. In the exemplary embodiments, the pressure washer 1 is configured so that the control element 42 does not trigger any function when actuated without simultaneous actuation of the valve control element 41. In this case, there is at least no change in the liquid volume flow in the main line 5 triggered by the control element 42, in particular no change triggered by the volume flow setting device 25. This separation of mechanical actuation and functional enablement is achieved through the control system.

The main line valve 8 can be switched between the fully open state and the closed state by means of the valve control element 41. The liquid volume flow of the liquid in the main line 5 in the section between the high-pressure pump 3 and the dispensing nozzle 6 can be influenced, in particular changed, in particular predetermined, by means of the control element 42. The liquid volume flow, in particular the size of the liquid volume flow, of the liquid in the pressure chamber 10 can be influenced, in particular changed, in particular predetermined, by means of the control element 42. In particular the liquid volume flow, in particular the size of the liquid volume flow, of the liquid in the main line 5 in the section between the high-pressure pump 3 and the dispensing nozzle 6 can be influenced, in particular changed, in particular predetermined, by means of the control element 42 in the fully open state of the main line valve 8. Provision may be made for the pressure of the liquid in the main line 5 in the section between the high-pressure pump 3 and the dispensing nozzle 6 to be able to be changed, in particular set, by means of the control element 42.

For the volume flow setting device 25, a first exemplary embodiment is shown in FIG. 5 and a second exemplary embodiment is shown in FIG. 6.

In the exemplary embodiment according to FIG. 5, the pressure washer 1, in particular the pump unit 18, has a bypass line 12. The pressure chamber 10 is fluidically connected to the suction chamber 9 through the bypass line 12. The bypass line 12 allows a further fluidic connection between suction chamber 9 and pressure chamber 10 separately from the fluidic connection between the suction chamber 9 and the pressure chamber 10 via the high-pressure pump 3.

When the high-pressure pump 3 is operating, the pressure in the pressure chamber 10 is higher than in the suction chamber 9. Due to this pressure gradient, liquid can flow from the pressure chamber 10 into the suction chamber 9 through the bypass line 12. A bypass valve 13 is arranged in the bypass line 12. A free cross-sectional area of the bypass line 12 can be set by means of the bypass valves 13. This allows the pressure in the pressure chamber 10 to be regulated. With a larger free cross-sectional area, there is greater pressure equalization between the pressure chamber 10 and the suction chamber 9. If a high pressure is desired in the pressure chamber 10, the free cross-sectional area of the bypass line 12 is reduced by means of the bypass valve 13. The larger the free cross-sectional area of the bypass line 12, in particular of the bypass valve 13, the greater the volume flow through the bypass line 13, in particular through the bypass valve 13, during operation, under otherwise unchanged conditions.

The bypass valve 13 can be adjusted incrementally or continuously between a fully closed state and a fully open state. The bypass valve 13 can have different degrees of closure between the fully closed state and the fully open state. In the exemplary embodiments, the bypass valve 13 is at least partially continuously adjustable. Provision may also be made for the bypass valve to be continuously adjustable between the fully closed state and the fully open state. The bypass valve 13 can be adjusted by means of an actuator 16. The actuator 16 is arranged in the pump unit 18. The bypass valve 13 can be adjusted by means of the actuator 16 such that the free cross-sectional area of the bypass line 12 can be set.

In the exemplary embodiment according to FIG. 5, the volume flow setting device 25 comprises the bypass line 12, the bypass valve 13 and the actuator 16. In particular, the bypass valve 13 can be actuated depending on, in particular, the intensity of the control signal generated by the control element 42. In particular, the degree of closure of the bypass valve 42 depends on the control signal, in particular the intensity of the control signal.

For all exemplary embodiments, the control device 7, in particular the control element 42, generates a control signal that depends on an actuation, in particular on a degree of actuation of the control device 7, in particular of the control element 42. The volume flow setting device 25 sets the liquid volume flow in the main line 5, in particular in the pressure chamber 10, on the basis of the control signal. The liquid volume flow can be adjusted, in particular changed, in particular set, by means of the control element 42 so that the size of the liquid volume flow can take on at least three different values. Provision may also be made for the size of the liquid volume flow to be able to be quasi-continuously, in particular continually, adjusted, in particular predetermined, by means of the control element 42.

The size of the liquid volume flow can be influenced, in particular changed, in particular set, depending on the degree of actuation of the control element 42.

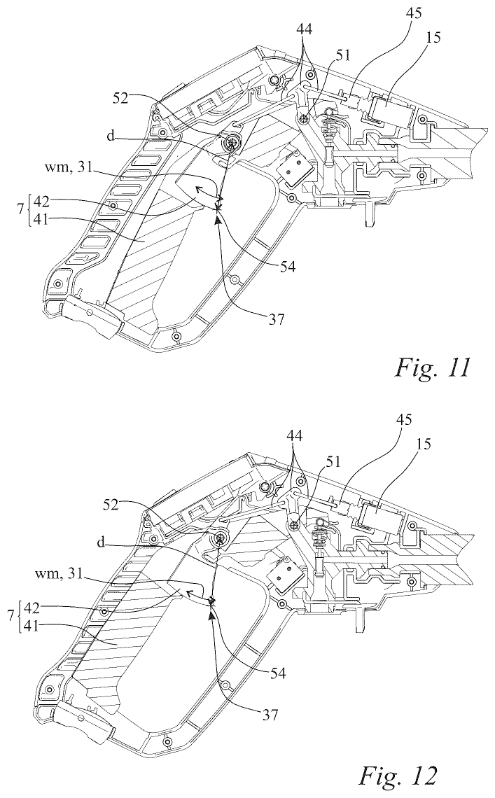

In the unactuated state, the control element 42 is in a rest position 37, as shown in FIG. 11 or 12. The control element 42 can be adjusted along an adjustment path 31, in particular to different adjustment positions. The adjustment path 31 is limited by the rest position 37 and the end position 38. The control element 42 is pre-tensioned into the rest position 37.

The pressure washer 1 is configured so that the bypass valve 13 sets the size of the free cross-sectional area depending on the adjustment position of the control element 42. The control element 42 generates a control signal depending on the adjustment position of the control element 42. Different control signals can be generated by means of the control element 42. On the basis of the control signal, the volume flow setting device 25 sets the liquid volume flow in the main line 5, in particular in the pressure chamber 10.

In particular, the size of the free cross-sectional area can be adjusted to at least six, in particular to at least ten, levels by means of the control element 42. Provision may also be made for the size of the free cross-sectional area to be able to be continually adjusted by means of the control element. In the exemplary embodiments, the size of the free cross-sectional area can be adjusted by means of the control element 42 in particular in a maximum of 30, in particular in a maximum of 20, levels. In the exemplary embodiments, the size of the free cross-sectional area can be adjusted quasi-continuously by means of the control element 42. Quasi-continuously here means that the different liquid volume flow stages are so close together that it appears to the user as if the pressure is being continuously adjusted when they actuate the control element 42.

Depending on the degree of closure of the bypass valve 13, the size of the volume flow of the liquid in the main line 5, in particular in the pressure chamber 10, can be set. The more the bypass valve 13 is closed, the smaller the free cross-sectional area of the bypass line 12. The more the bypass valve 13 is closed, the greater the volume flow of the liquid in the main line 5, in particular in the section between the high-pressure pump 3 and the dispensing nozzle 6. The more the bypass valve 13 is closed, the greater the volume flow of the liquid in the main line 5 present at the dispensing nozzle 6.

The bypass valve 13 can be adjusted by means of the control device 7, in particular by means of the control element 42, in particular on the basis of the control signal. In the exemplary embodiments, the control element 42 serves to set the free cross-sectional area of the bypass line 12. The liquid volume flow in the main line 5, in particular in the pressure chamber 10, in particular at the dispensing nozzle 6, can be regulated by adjusting the bypass valve 13.

In the exemplary embodiment according to FIG. 6, the pressure in the main line 5, in particular in the pressure chamber 10, is changed, in particular set, by means of an alternative volume flow setting device 25. In contrast to the exemplary embodiment shown in FIG. 5, the exemplary embodiment shown in FIG. 6 does not include a bypass line. To influence, in particular change, in particular adjust, in particular set the liquid volume flow in the main line 5, in particular in the pressure chamber 10, the motor speed of the motor 4 for driving the high-pressure pump 3 can be varied in the exemplary embodiment shown in FIG. 6. In this case, the control element 42 serves to predetermine, in particular set, a motor speed of the motor 4. In particular, the size of the liquid volume flow depends on the speed of the motor 4. The greater the speed of the motor 4, the greater the liquid volume flow, in particular its size. In the exemplary embodiment shown in FIG. 6, the volume flow setting device 25 comprises the motor 4 and the high-pressure pump 3. In this exemplary embodiment too, the control device 7, in particular the control element 42, generates a control signal dependent on an actuation, in particular on a degree of actuation of the control device 7, in particular of the control element 42, and the volume flow setting device 25 sets the liquid volume flow in the main line 5, in particular in the pressure chamber 10, on the basis of the control signal. In the exemplary embodiment shown in FIG. 6, the speed of the motor 4 is changed, in particular set, depending at least indirectly on the control signal, in particular an intensity of the control signal. In particular, the speed of the motor 4 can be influenced, in particular changed, in particular set, depending on the control signal generated by the control element 42, in particular depending on the intensity of the control signal.

The pressure washer 1 is configured in the exemplary embodiment shown in FIG. 6 so that the motor speed of the motor 4 is set depending on the adjustment position of the control element 42. The greater the motor speed of the motor 4, the greater the liquid volume flow, in particular the pressure, of the liquid in the main line 5, in particular in the pressure chamber 10.

Both the main line valve 8 can be switched between the fully open state and the closed state, and the pressure in the main line 5 in the section between the high-pressure pump 3 and the dispensing nozzle 6 can be predetermined, in particular set, by means of the control device 7.

The dispensing unit 11 can be moved relative to the pump unit 18. In the exemplary embodiments, the main line 5 between the pump unit 18 and the dispensing unit 11 is designed as a flexible hose. The dispensing nozzle 6 is arranged on the dispensing unit 11. The dispensing unit 11 can be directed at an object to be cleaned using its dispensing nozzle 6. The dispensing unit 11 is hand-held. The control device 7 is arranged on the dispensing unit 11. A user can operate the dispensing unit 11 with one hand and simultaneously operate the control device 7 with the same hand.

The control device 7 is pre-tensioned in an unactuated state. Both the valve control element 41 and the control element 42 are independently pre-tensioned to an unactuated state. A spring (not shown in the figures) can be used for this purpose.

In the exemplary embodiments, the control device 7 is configured so that the control element 42 can only be actuated when the valve control element 41 is actuated. However, provision may also be made for the control element 42 to be able to be actuated when the valve control element 41 is unactuated.

The pressure washer 1 is configured so that, when the valve control element 41 is actuated, the main line valve 8 is moved from the fully closed state to the fully open state.

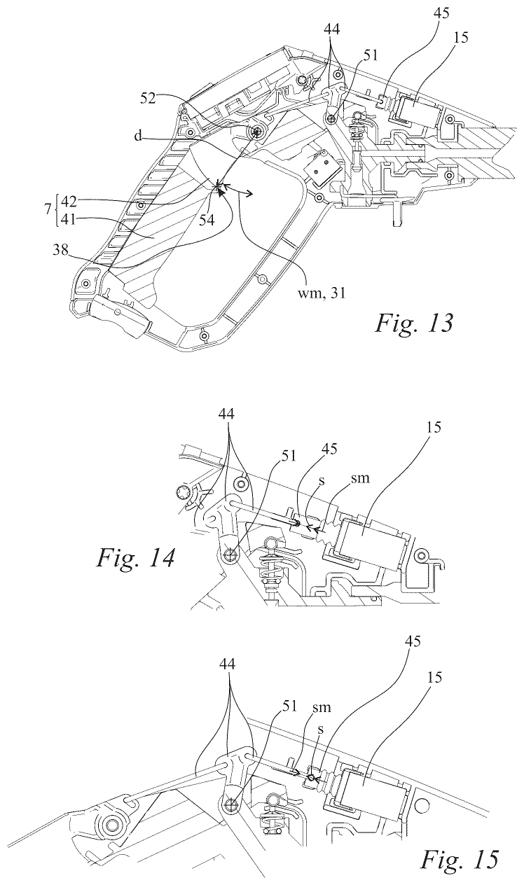

The control element 42 can be adjusted along the adjustment path 31 shown in FIGS. 11 to 13 for all exemplary embodiments. The adjustment path 31 is also referred to as the adjustment range. The control element 42 can assume different adjustment positions within the adjustment range, in particular depending on the degree of actuation of the control element 42. Provision may be made for the control element 42 to be able to be adjusted exclusively in steps. In the exemplary embodiments, the control element 42 can be continuously adjusted to different adjustment positions within the adjustment range 31.

The pressure washer 1 comprises a detector 15. The detector 15 is shown schematically in FIGS. 5 and 6. The detector 15 is shown in more detail in the sectional views of the technical drawings according to FIGS. 11 to 15. The detector 15 is configured to detect the adjustment position, in particular the degree of actuation, of the control device 7, in particular of the control element 42 of the control device 7. The detector 15 can detect any continuous adjustment position of the control device 7, in particular of the control element 42, within the adjustment range, in particular along the adjustment path 31. Provision may be made for detector 15 to be a Hall sensor. In the exemplary embodiment, detector 15 is a potentiometer. The control device 7, in particular the control element 42, and the detector 15 are arranged on the dispensing unit 11 so that the adjustment position of the control device 7, in particular of the control element 42, can be detected. The control element 42 interacts with the detector 15 at least indirectly. In the exemplary embodiments, a mechanical connecting element 44 is arranged between the detector 15 and the control device 7, in particular the control element 42, as shown in FIGS. 11 to 13. The mechanical connecting element 44 couples the control device 7, in particular the control element 42, and the detector 15 to one another. The control device 7, in particular the control element 42, interacts with the detector 15 by means of the mechanical connecting element 44.

The detector 15 has a position element 45. The position element 45 can be adjusted along a maximum detector path sm. The maximum detector path sm and the position element 45 are shown enlarged in FIGS. 14 and 15. The detector 15 generates a control signal based on a detector path s travelled by a position element 45 of the detector 15 along the maximum detector path sm, this signal being used to influence, in particular change, in particular set, in particular predetermine, the size of the liquid volume flow in the main line 5. In the exemplary embodiments, the position element 45 is a slider of the detector 15 designed as a potentiometer. However, provision may also be made for the position element to be a magnet of the detector designed as a Hall sensor. FIG. 14 shows the position element 45 with the control element 42 unactuated. FIG. 15 shows the position element 45 with the control element 42 fully actuated. Due to the actuation of the control element 42, the position element 45 is moved by the detector path s along the maximum detector path sm. In the process, the position element 45 is moved relative to a measuring unit of the detector 15, in the exemplary embodiment of a coil. The change in position of the position element 45 is detected by the measuring unit of the detector 15. In the exemplary embodiments, the control signal is generated here. The control signal corresponds to the signal generated in the detector 15 upon detection of the position, in particular the adjustment position, of the control element 42, in particular the position of the position element 45. The control signal is generated indirectly by the control device 7, in particular the control element 42. In particular, the control signal is generated indirectly depending on the actuation, in particular the degree of actuation, of the control device 7, in particular the control element 42. However, the control signal may also be a different signal generated on the signal path between the control device 7 and the volume flow setting device 25.

The mechanical connecting element 44 mechanically connects the positioning element 45 and the control element 42 to one another.

As shown in particular in FIGS. 11 to 13 by way of example for all exemplary embodiments, the control element 42 can be adjusted along the adjustment path 31, in particular within the adjustment range of the control element 42, from the rest position 37 to adjustment positions with increasing distance from the rest position 37. The control element 42 reaches the maximum distance from the rest position 37 in the end position 38. In the end position 38, the control element has travelled the maximum adjustment path wm. The pressure washer 1 is configured so that control signals with greater or lesser intensity are generated as the distance of the control element 42 from the rest position 37 increases. In the exemplary embodiment, the intensity of the control signals increases with increasing distance of the control element 42 from the rest position 37. The control signal, in particular the intensity of the control signal, depends on the degree of actuation of the control element. With increasing intensity of the control signals, the volume flow setting device 25 in the main line 5, in particular in the pressure chamber 10, sets a larger or at least no smaller liquid volume flow. When the control element 42 is in the end position 38, it, in particular the detector 15, generates a control signal of maximum intensity. Then, by means of the volume flow setting device 25, a maximum possible liquid volume flow is set in the main line 5, in particular in the pressure chamber 10.

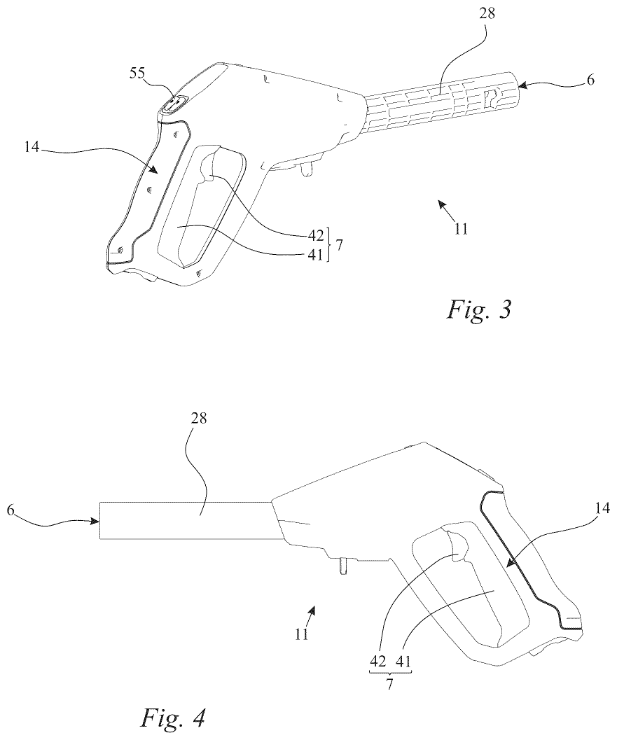

The distance from the rest position 37 refers to the distance of a reference point on the control element 42. In the exemplary embodiments, the control element 42 is a pivot lever which can be pivoted about a control element pivot axis 52. In the exemplary embodiment, the reference point is the point on the control element 42 at the greatest distance from the control element pivot axis 52. This point is referred to as the pressure point 54 and is shown in FIGS. 11 to 13. The corresponding distance of the pressure point 54 from the control element pivot axis 52 is referred to as the maximum pressure distance d. The pressure point 54 is arranged, relative to the control element pivot axis 52. on the side of the control element 42 which is actuated by the operator. The pressure point 54 is the point on the control element 42 which is arranged, relative to the location of the control element pivot axis 52, on the side of the control element 42 which is facing away from a grip area 14 (FIG. 3 or 4) where the hand, in particular the middle of the hand, in particular the palm, of a user rests during operation of the pressure washer 1, and which is at the maximum pressure distance d (FIGS. 11 to 13) from the control element pivot axis 52. The rest position 37 is defined in the exemplary embodiments by the position of the reference point when the control element 42 is unactuated.

When the control element 42, designed as a pivot lever, is actuated in the rest position 37 of the control element 42, the control element 42—and thus also the reference point—is pivoted along the adjustment path 31, in particular within the adjustment range. The adjustment path 31 is, in this case, a circular segment. The distance of the control element 42 from the rest position 37 corresponds to the distance of the reference point from the rest position 37 measured along the adjustment path designed as a circular segment. For clarity, the adjustment path is arranged slightly radially offset from the pressure point 54 in FIGS. 11 to 13. In fact, the arc segment line extends from the position of the pressure point 54 in FIG. 11. The pressure point 54 moves along a circular path with respect to the pivoting movement about the control element pivot axis 52. Provision may also be made for the distance to be measured as an angular distance of the reference point from the rest position with respect to a pivoting movement about the control element pivot axis 52.

The control element 42 can be adjusted along the adjustment path 31 until it has travelled the maximum adjustment path wm (FIGS. 11 to 13). The maximum adjustment path wm corresponds to the distance measured between the rest position 37 and the end position 38 along the adjustment path 31. The maximum adjustment path wm of the control element 42 is at least 110%, in particular at least 150%, in particular at least 200% of the maximum detector path sm of the position element 45. The movement of the control element 42 along its adjustment path 31 is translated into a movement of the position element 45 along its adjustment path. Here, a pivoting movement of the control element 42 is converted into a linear movement of the position element 45. For this purpose, the mechanical connecting element 45 comprises several joints.

The pressure washer 1 is configured in all exemplary embodiments so that the volume flow setting device 25 sets the liquid volume flow depending on the adjustment position of the control element 42. For this purpose, the detector 15 detects the adjustment position of the control element 42 and generates a signal, in particular the control signal, based on which the volume flow setting device 25 sets the liquid volume flow in the main line 5, in particular in the pressure chamber 10.

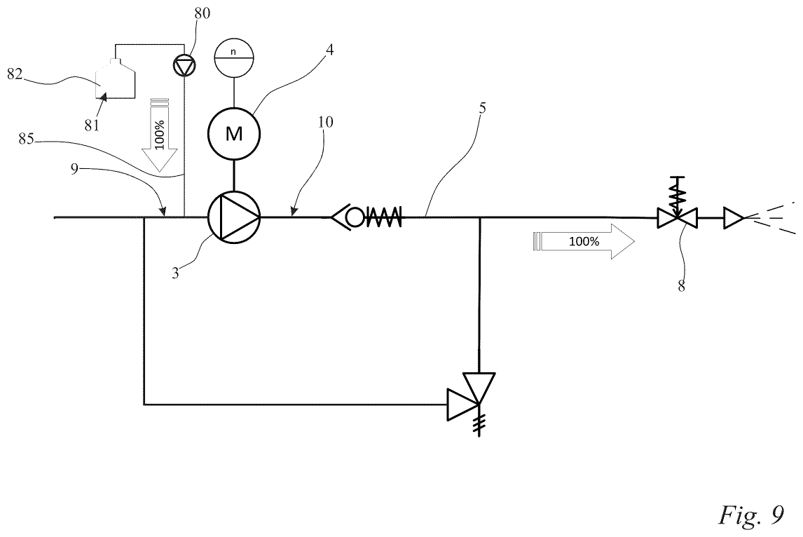

In the exemplary embodiments, the valve control element 41 is a pivot lever pivotable about a valve control element pivot axis 51 shown in FIGS. 9 to 11. In particular, the valve control element 41 is pivotable about the valve control element pivot axis 51 in the dispensing unit 11, in particular in a housing of the dispensing unit 11. In particular, the control element 42 is a pivot lever pivotable about a control element pivot axis 52 shown in FIGS. 11 to 13.

The pressure washer 1 has a control unit 22 shown in FIGS. 5 and 6. The control unit 22 is arranged in the pump unit 18. Provision may also be made for the control unit 22 to be arranged in the dispensing unit 11. The signal generated by the detector 15, in particular the control signal, is transmitted directly or indirectly, in particular in the form of a wireless, in particular electromagnetic, signal to the control unit 22. The signal received by the control unit 22 is used to influence, in particular change, in particular set, the liquid volume flow, in particular the size of the liquid volume flow, in the section of the main line 5 between the high-pressure pump 3 and the dispensing nozzle 6, in particular by means of the volume flow setting device 25. In particular, a liquid volume flow signal, in particular with a determined intensity, is generated by the control unit 22 on the basis of the control signal received by the control unit 22, in particular on the basis of the intensity of the control signal. The liquid volume flow signal is transmitted from the control unit 22 to the volume flow setting device 25. The liquid volume flow signal is transmitted from the control unit 22 to the volume flow setting device 25 in particular directly or indirectly, in particular as a wireless, in particular electromagnetic, signal. However, provision may also be made for the liquid volume flow signal to be transmitted via cable, in particular as an electrical signal. The volume flow setting device 25 sets the liquid volume flow in the main line 5, in particular in the pressure chamber 10, according to the liquid volume flow signal, in particular according to the intensity of the liquid volume flow signal.

The pressure washer 1 comprises, in all exemplary embodiments, a mixing device 80 shown in FIGS. 5 and 6. The mixing device 80 serves to mix an additive 81 to the liquid. In the exemplary embodiments, the additive 81 is a cleaning agent solution. The pressure washer 1 is configured in the exemplary embodiments so that the additive 81 can be fed to the main line 5, in particular upstream of the high-pressure pump 3, via the mixing device 80. The additive 81 is fed directly to the main line 5, in particular upstream of the high-pressure pump 3. In the exemplary embodiments, the additive 81 passes directly from the mixing device 80 into the area of main line 5 upstream of the high-pressure pump 3, without first passing through the area of the main line 5 downstream of the high-pressure pump 3. However, provision may also be made for the mixing device 80 to introduce the additive 81 directly into the pressure chamber 10.

In the exemplary embodiments, the mixing device 80 is an auxiliary pump. The auxiliary pump is designed separately from the high-pressure pump 3. The auxiliary pump pressurizes the additive 81 autonomously, independently of the high-pressure pump 3. The auxiliary pump is not a hydraulic actuator. The auxiliary pump is the primary source of energy for the movement of the additive 81. The auxiliary pump generates the energy to move the additive 81. In particular, the auxiliary pump does not use the hydraulic pressure generated by the high-pressure pump to move the additive 81.

Provision may be made for the auxiliary pump to comprise a rotating driven motor. This is not the case in the exemplary embodiments.

The mixing device 80, in particular the auxiliary pump, has an outlet 84, as shown in FIGS. 5 and 6. The outlet 15 of the mixing device 80 is fluidically connected to the main line 5, in particular to the suction chamber 9. In the exemplary embodiments, the pressure washer 1 comprises a branch line 85. The branch line 85 is arranged between the outlet 84 and the main line 5, in particular to the suction chamber 9. The outlet 84 of the mixing device 80 is fluidically connected to the main line 5, in particular to the suction chamber 9, by means of the branch line 85. The branch line 85 serves to supply the additive 81 to the main line 5, in particular to the pressure chamber 10, by means of the mixing device 80, in particular the auxiliary pump.

An additive volume flow can be generated by means of the mixing device 80. The additive volume flow is the volume flow of the additive 81 to the liquid, in particular in the main line 5, in particular in the suction chamber 9. In particular, the additive volume flow is the volume flow of the additive 81 in the branch line 85, in particular at the connection point of branch line 85 and main line 5, in particular suction chamber 9.

The mixing device 80 sets the additive volume flow on the basis of the control signal.

The pressure washer 1 is configured so that the additive volume flow can be influenced, in particular changed, in particular set by means of the control element 42. In particular, the size of the additive volume flow depends on the degree of actuation of the control element 42.

The size of the additive volume flow is influenced, in particular changed, in particular predetermined, in particular set, by the mixing device 80 exclusively on the basis of the control signal generated by the control element 42, in particular exclusively on the basis of the intensity of the control signal generated by the control element 42. In particular, the mixing device 80 sets the additive volume flow exclusively on the basis of the control signal, in particular exclusively on the basis of the intensity of the control signal. Although the control signal can be amplified or converted into another signal beforehand, the control signal always serves as the basis for measuring any other signal. The signal chain between the control signal and the mixing device 80 comprises exclusively electrical and/or electromagnetic signals. After the control signal is generated, it is transmitted to the mixing device 80 without the involvement of mechanical and/or hydraulic signals. In particular, the liquid volume flow does not need to be measured to determine the delivery rate of the mixing device 80. In particular, the speed of the motor 3 for driving the high-pressure pump 4 and/or the volume flow in the bypass line 12 do not need to be determined to determine the delivery rate of the mixing device 80. In particular, the position of the bypass valve 13 does not need to be detected to determine the delivery rate of the mixing device 80.

The mixing device 80 receives an additive volume flow signal, in particular from the control unit 22, in order to set the size of the additive volume flow. The additive volume flow signal is determined, in particular ascertained, in particular generated, exclusively on the basis of the control signal. The delivery rate of the mixing device 80 depends on the additive volume flow signal, in particular on the intensity of the additive volume flow signal. The delivery rate of the mixing device 80 depends on the control signal, in particular on the intensity of the control signal. The additive volume flow signal depends on the control signal. In particular, the intensity of the additive volume flow signal depends on the intensity of the control signal.

In all exemplary embodiments, both the volume flow setting device 25 sets the liquid volume flow in the main line 5, in particular in the pressure chamber 10, and the mixing device 80 sets the size of the additive volume flow on the basis of the control signal, in particular on the basis of the intensity of the control signal.

In particular, the size of the additive volume flow is proportionally dependent on the size of the liquid volume flow in the main line 5, in particular in the pressure chamber 10. This is achieved by the fact that both the size of the additive volume flow and the size of the liquid volume flow are derived directly from the control signal, in particular the intensity of the control signal. All subsequent signals are generated on the basis of the control signal. In particular, the intensity of all subsequent signals is determined depending on the intensity of the control signal. In particular, the additive volume flow signal is the direct result of an uninterrupted chain of exclusively electrical and/or electromagnetic signals the intensities of which are always dependent on one another and which originate from the control signal, in particular the intensity of the control signal. In particular, the liquid volume flow signal is the direct result of an uninterrupted chain of exclusively electrical and/or electromagnetic signals the intensities of which are always dependent on one another and which originate from the control signal, in particular the intensity of the control signal.

Provision may also be made for the additive volume flow signal to be the control signal. In the exemplary embodiments, the control signal generated by the control element 42, in particular generated when the adjustment position of the control element 42 is detected, is transmitted to the control unit 22. The control unit 22 generates both the liquid volume flow signal and the additive volume flow signal on the basis of the control signal, in particular the intensity of the control signal. The liquid volume flow signal is transmitted by the control unit 22 to the volume flow setting device 25 as described above. The additive volume flow signal is transmitted by the control unit 22 to the mixing device 80, in particular the auxiliary pump.

The pressure washer 1 comprises the transmitter unit 20 shown in FIGS. 5 and 6 for transmitting the control signal to the control unit 22. The transmitter unit 20 is arranged on the dispensing unit 11. The control unit 22 is arranged in the pump unit 18. In the exemplary embodiments, the control signal is transmitted to the control unit 22 by means of an intermediate signal. The transmitter unit 20 receives the control signal, in particular directly from the detector 15, in particular as an electrical signal. The transmitter unit 20 generates the intermediate signal directly from the control signal. The intensity of the intermediate signal depends on the intensity of the control signal. The intensity of the intermediate signal is in particular proportional to the intensity of the control signal. The intermediate signal is transmitted to the control unit 22 wirelessly. In the exemplary embodiments, the intermediate signal is an electromagnetic signal. However, provision may also be made for the intermediate signal to be an electrical signal and transmitted to the control unit 22 by means of an electrical cable. The control unit 22 receives the intermediate signal and directly generates the liquid volume flow signal and the additive volume flow signal from the intermediate signal.

The control unit 22 sends the additive volume flow signal to the mixing device 80. The control unit 22 controls the mixing device 80, in particular the auxiliary pump, in particular the power supply to the auxiliary pump, depending on the control signal, in particular the additive volume flow signal. Provision may also be made for the control unit 22 to control a motor for the auxiliary pump, in particular the power supply to a motor 4 for the auxiliary pump, depending on the control signal, in particular the additive volume flow signal.

The additive volume flow signal is transmitted from the control unit 22 to the mixing device 80 in particular directly or indirectly, in particular as a wireless, in particular electromagnetic, signal. However, provision may also be made for the additive volume flow signal to be transmitted via cable, in particular as an electrical signal. The mixing device 80 sets the additive volume flow in the main line 5, in particular in the pressure chamber 10, according to the additive volume flow signal, in particular according to the intensity of the additive volume flow signal. In particular, the delivery rate of the mixing device 80, in particular the pump output of the auxiliary pump, is set according to the additive volume flow signal, in particular according to the intensity of the additive volume flow signal.

In particular, the delivery rate of the mixing device 80, in particular the auxiliary pump, is set by clocking the electrical energy, in particular the electrical power, with which the mixing device 80, in particular the auxiliary pump, is operated. The electrical power is clocked depending on the control signal, in particular the intensity of the control signal. An effective output power is obtained by clocking the electrical power. The effective output power is also referred to as the active power or average power. The greater the intensity of the control signal, the greater the effective power.

The power supply to the mixing device 80, in particular the auxiliary pump, can advantageously be set by means of pulse width modulation. Here, the power supply is only allowed at time intervals, what are referred to as the pulses. Between two pulses, the power supply is suppressed. Provision may also be made for the power supply of a motor of the auxiliary pump to be able to be set by means of pulse width modulation.

As shown in FIGS. 5 and 6, the mixing device 80, in particular the auxiliary pump, comprises an inlet 83. The inlet 83 of the mixing device 80 is fluidically connected to a container 82 for the additive 81. Provision may be made for the container 82 to be part of the pressure washer 1. In the exemplary embodiments, the container 82 for the additive 81 is designed separately from the pressure washer 1. The container 82 is interchangeably held in the pressure washer 1. The container 82 is arranged in the pump unit 18.

The pressure washer 1 comprises an auxiliary valve 86. The auxiliary valve 86 prevents liquid from the main line 5 from entering the container 82 for the additive 81. In the exemplary embodiments, the auxiliary valve 86 is arranged in the branch line 85. Provision may also be made for the auxiliary valve 86 to be arranged in the connecting line between the container 82 and the mixing device 80, in particular the auxiliary pump. Provision may also be made for the auxiliary valve 86 to be part of the mixing device 80, in particular the auxiliary pump.

In the exemplary embodiments, the pressure washer 1 comprises a backflow preventer 87. The backflow preventer 87 prevents the additive 81 from escaping from the main line 5 through the connection 2 for the liquid source 17 in the direction of the liquid source 17. The backflow preventer 87 is arranged in the main line 5 upstream of the high-pressure pump 3. The backflow preventer 87 is arranged in the suction chamber 9. The backflow preventer 87 is arranged in the area of the main line 5 between the mixing device 80, in particular the auxiliary pump, and the connection 2. The backflow preventer 87 is arranged between the branch line 85 and connection 2 in the main line 5. Instead of the backflow preventer 87, a check valve can also be provided.

In the exemplary embodiments, the mixing device 80, in particular the auxiliary pump, is an oscillating armature pump. The oscillating armature pump is a type of pump which is driven by an oscillating armature instead of a rotating motor. The oscillating armature pump may be a diaphragm pump or a vibration pump. In the exemplary embodiments, the auxiliary pump is a vibration pump.

In the vibration pump, an AC-driven electromagnet, via a yoke in an internal air gap, generates an oscillating magnetic field which causes a ferromagnetic armature to vibrate against a pressure spring. This armature simultaneously represents the piston through whose central bore liquid can flow into a pump chamber of the auxiliary pump. When the piston swings out of the air gap of the electromagnet due to the spring force, a valve closes the bore in the piston and a further valve opens the pump chamber of the auxiliary pump towards the outlet 84 of the auxiliary pump. If the piston is pulled back into the air gap by the magnetic field, the outlet valve closes again and the cycle begins anew. However, the auxiliary pump 4 may also be a vibrating armature diaphragm pump or a linear diaphragm pump.

For the vibration decoupling of the housing of the pump unit 18 and the auxiliary pump, the auxiliary pump can be mounted in the pump unit 18 by means of an anti-vibration element, in particular by means of an elastomer.

The pressure washer 1 has an additional control element 60 shown in FIGS. 5 and 6. The additional control element 60 serves to activate the mixing device 80, in particular the auxiliary pump. The mixing device 80 only delivers the additive 81 when the additional control element 60 has been and/or is being actuated. Without actuation of the additional control element 60, the mixing device 80 is not supplied with electrical power.

The additional control element 60 is arranged on the dispensing unit 11. The additional control element 60 is arranged on the dispensing unit 11 in such a way that a user can operate the dispensing unit 11 with one hand and simultaneously actuate the additional control element 80 with the same hand. In the exemplary embodiments, a single actuation of the additional control element 60 is sufficient to activate the mixing device 80. The level of electrical power supplied to the mixing device 80 is then determined by the control element 42, in particular by the degree of actuation of the control element 42, in particular by the control signal, in particular by the intensity of the control signal.

The mixing device 80, in particular the auxiliary pump, can be operated when the additional control element 60 is activated. The mixing device 80, in particular the auxiliary pump, cannot be operated when the additional control element 60 is deactivated. The mixing device 80, in particular the auxiliary pump, cannot be operated when the additional control element 60 is deactivated, even if the control element 42 is actuated. Provision may be made for the additional control element 60 to comprise a button. In a first, pressed position, the additional control element 60 is in the activated state. In a second, unpressed position, the additional control element 60 is in the deactivated state.

The pressure washer 1 is configured so that the mixing device 80, in particular the auxiliary pump, is only operated when the additional control element 80 is in the activated state and the valve control element 41 is actuated simultaneously. The mixing device 80, in particular the auxiliary pump, can only deliver additive 81 into the main line 5 when the main line valve 8 is opened by means of the valve control element 41. The mixing device 80, in particular the auxiliary pump, only delivers additive 81 into the main line 5 when the main line valve 8 is opened by means of the valve control element 41, the additional control element 60 is simultaneously in the activated state and the control element 42 is actuated. Liquid containing additive 81 is then dispensed from the dispensing nozzle 6.

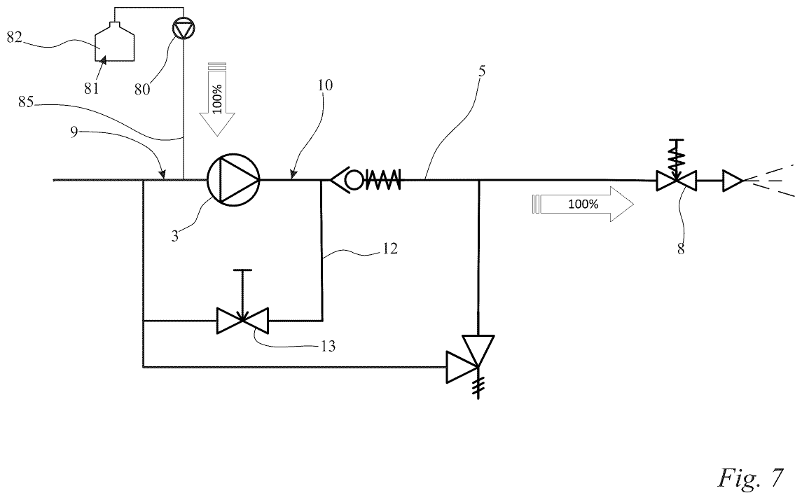

When the control element 42 is actuated with the maximum possible degree of actuation, that is to say when the control element 42 is adjusted to the end position 38, a control signal with maximum intensity is generated. As shown in FIG. 7 for the exemplary embodiment according to FIG. 5 and in FIG. 9 for the exemplary embodiment according to FIG. 6, the liquid volume flow in the main line 5, in particular in the pressure chamber 10, is then set to its maximum on the basis of the control signal, in particular on the intensity of the control signal. The additive volume flow is likewise set to its maximum on the basis of the control signal, in particular on the intensity of the control signal, in particular in branch line 85.

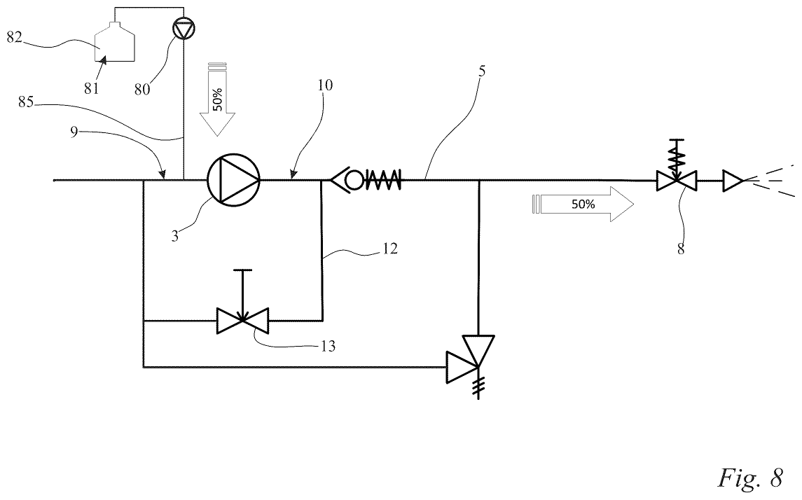

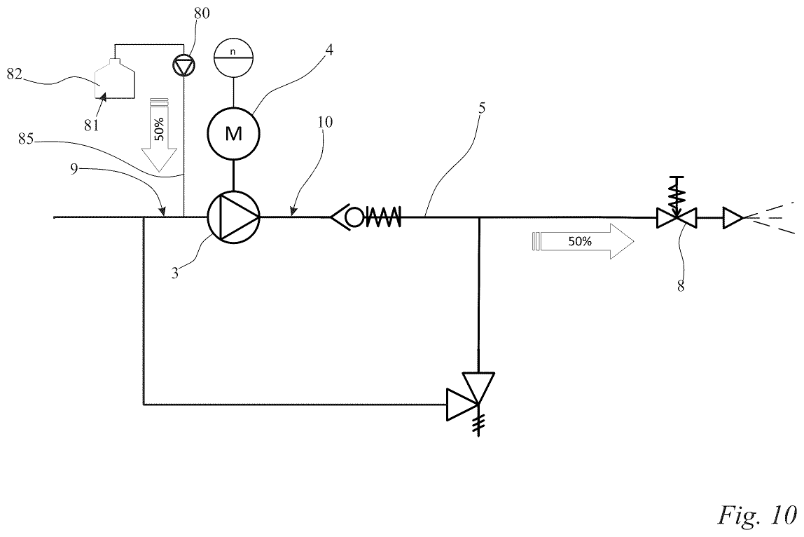

If the control element 42 is then actuated with only half the degree of actuation, that is to say if it has travelled only half of the maximum adjustment path wm along adjustment path 31, that is to say if it is located midway between rest position 37 and end position 38 along adjustment path 31, a control signal is generated whose intensity corresponds to half the maximum possible intensity. As shown in FIG. 8 for the exemplary embodiment according to FIG. 5 and in FIG. 10 for the exemplary embodiment according to FIG. 6, the liquid volume flow in main line 5, in particular in pressure chamber 10, is then set to half the maximum possible liquid volume flow on the basis of the control signal, in particular on the intensity of the control signal. The additive volume flow is likewise set to half the maximum possible additive volume flow on the basis of the control signal, in particular on the intensity of the control signal, in particular in branch line 85.

This ensures in a simple way that the concentration of the additive 81 in the liquid which is delivered and injected by the high-pressure pump 3 is always almost, in particular exactly, constant.

What is claimed is:

1. A pressure washer, comprising:
a high-pressure pump (3);
a main line (5) configured to deliver a liquid from the high-pressure pump (3);
a control element (42) configured to generate a control signal and thereby influence a liquid volume flow rate of the liquid in the main line (5); and
a mixing device (80) configured to supply an additive (81) to the liquid at an additive volume flow rate,
wherein the mixing device (80) is configured to set the additive volume flow rate based on the control signal.

2. The pressure washer according to claim 1,
wherein the liquid volume flow rate is selectable among at least three different values or is continuously adjustable.

3. The pressure washer according to claim 1,
wherein the control element (42) is continuously adjustable along an adjustment path (31) between a rest position (37) and an end position (38),
wherein an intensity of the control signal increases as a distance of the control element (42) from the rest position (37) increases towards the end position (38), and
wherein the control element (42) is configured to continuously adjust the liquid volume flow rate.

4. The pressure washer according to claim 1,
wherein the control element (42) is configured to influence the liquid volume flow rate depending on a degree of actuation of the control element (42).

5. The pressure washer according to claim 4,
wherein the additive volume flow rate depends on the degree of actuation of the control element (42).

6. The pressure washer according to claim 4,
wherein the control signal depends on the degree of actuation of the control element (42).

7. The pressure washer according to claim 1,
further comprising a volume flow setting device (25) configured to set the liquid volume flow rate,
wherein the volume flow setting device (25) is configured to set the liquid volume flow rate based on the control signal.

8. The pressure washer according to claim 1,
wherein the mixing device (80) is configured to receive an additive volume flow signal for setting the additive volume flow rate, and
wherein the additive volume flow signal is determined exclusively based on the control signal.

9. The pressure washer according to claim 1,
wherein the pressure washer is configured such that the additive volume flow rate is proportional to the liquid volume flow rate.

10. The pressure washer according to claim 1,
wherein the mixing device (80) comprises an auxiliary pump configured to supply the additive to the liquid in the main line (5).

11. The pressure washer according to claim 10,
wherein the additive volume flow rate is set by pulsing electrical power supplied to the auxiliary pump.

12. The pressure washer according to claim 1,
wherein the main line (5) includes a suction chamber (9) and a pressure chamber (10),
wherein the high-pressure pump (3) is arranged between the suction chamber (9) and the pressure chamber (10),
wherein the pressure chamber (10) is in fluid communication with the suction chamber (9) via a bypass line (12),
wherein a bypass valve (13) is arranged in the bypass line (12) and is configured to set a free cross-sectional area of the bypass line (12) in order to regulate the liquid volume flow in the pressure chamber (10) of the main line (5), and
wherein the bypass valve (13) is actuated, directly or indirectly, by the control element (42).

13. The pressure washer according to claim 1,
further comprising a motor (4) configured to drive the high-pressure pump (3),
wherein the liquid volume flow rate depends on a speed of the motor (4), and
wherein the speed of the motor (4) is adjustable by the control element (42).

14. A method for operating a pressure washer, wherein the pressure washer (1) comprises
a high-pressure pump (3),
a main line (5) configured to deliver a liquid from the high-pressure pump (3);
a control element (42) configured to generate a control signal and thereby influence a liquid volume flow rate of the liquid in the main line (5), and
a mixing device (80) configured to supply an additive (81) to the liquid at an additive volume flow rate,
the method comprising:
setting both the liquid volume flow rate and the additive volume flow rate based on the control signal.

15. The method according to claim 14, further comprising
generating the control signal by actuating a control element (42) of the pressure washer (1).

16. The method according to claim 15,
wherein the control signal depends on a degree of actuation of the control element (42).
